(19) United States
(12) Patent Application Publication
(10) Pub. No.: US 2026/0017055 A1
(43) Pub. Date: Jan. 15, 2026

(54) METHOD AND APPARATUS FOR GENERIC SAMPLE AUXILIARY INFORMATION SIGNALLING

(71) Applicant: Nokia Technologies Oy, Espoo (FI)

(72) Inventors: Kashyap KAMMACHI SREEDHAR, Tampere (FI); Miska Matias HANNUKSELA, Tampere (FI)

(21) Appl. No.: 19/260,832

(22) Filed: Jul. 7, 2025

Related U.S. Application Data
(60) Provisional application No. 63/669,337, filed on Jul. 10, 2024.

(51) Int. Cl. G06F 9/30

(52) U.S. Cl. CPC G06F 9/30112; G06F 9/3013

(57) ABSTRACT

Various embodiments provide methods, apparatuses, and computer program products. An example apparatus includes at least one processor; and at least one memory storing instructions that, when executed by the at least one processor, cause the apparatus at least to perform: defining size information comprising size of each sample auxiliary information of one or more auxiliary information comprised in a track; defining offset information comprising offset of the each sample auxiliary information; and signaling the size information and the offset information.

### TECHNICAL FIELD

The examples and non-limiting embodiments relate generally to multimedia transport and, more particularly to, generic sample auxiliary information signaling.

### BACKGROUND

It is known to provide standardized formats for encoding, signaling, or decoding of media data.

### SUMMARY

Example 1: An apparatus comprising: at least one processor; and at least one memory storing instructions that, when executed by the at least one processor, cause the apparatus at least to perform: defining size information comprising size of each sample auxiliary information of one or more sample auxiliary information comprised in a track; defining offset information comprising offset of each sample auxiliary information; and signaling the size information and the offset information.

Example 2: The apparatus of claim 1, wherein the apparatus is further caused to perform: defining a new information box comprising information to process the one or more sample auxiliary information.

Example 3: The apparatus of any of the claim 1 or 2, wherein when the track comprises the one or more sample auxiliary information, the apparatus is further caused to perform: defining presence of the one or more sample auxiliary information by using the new information box.

Example 4: The apparatus of claim 2, wherein the new information box comprises a sample auxiliary information info box.

Example 5: The apparatus of any of the previous claims, wherein new information box is comprised in: a sample entry of the track, a sample table box, or in a track fragment box.

Example 6: The apparatus of any of the previous claims wherein, the apparatus is further caused to perform defining an entry count for providing a count of a number of entries of the one or more sample auxiliary information in the following array.

Example 7: The apparatus of claim 6, wherein the apparatus an array for indicating an entry for the sample auxiliary information.

Example 8: The apparatus of any of the previous claims, wherein the sample auxiliary information is protected using an encryption scheme.

Example 9: The apparatus of any of the previous claims, wherein the sample auxiliary information is encoded with a content encoding method.

Example 10: The apparatus of claim 9, wherein the content encoding method changes format of the sample auxiliary information data.

Example 11: The apparatus of any of the claims 8 to 10, wherein when both content encoding and protection are indicated for the sample auxiliary information, a reader needs to un-protect the sample auxiliary information data, before the sample auxiliary information content encoding is decoded.

Example 12: The apparatus of any of the claims 2 to 10, wherein the new information box comprises an array of entries, and wherein each entry comprises boxes comprising information needed to process the sample auxiliary information.

Example 13: The apparatus of any of the claims 2 to 11, wherein the apparatus is further caused to perform defining a protection box for providing an array of sample auxiliary information protection information for use by a corresponding sample auxiliary information in the new information box.

Example 14: A method comprising: defining size information comprising size of each sample auxiliary information of one or more sample auxiliary information comprised in a track; defining offset information comprising offset of the each sample auxiliary information; and signaling the size information and the offset information.

Example 15: The method of claim 14 further comprising defining a new information box comprising information to process the one or more sample auxiliary information.

Example 16: The method of any of the claim 14 or 15, wherein when the track comprises the one or more sample auxiliary information, the method further comprises: defining presence of the one or more sample auxiliary information by using the new information box.

Example 17: The method of claim 15, wherein the new information box comprises a sample auxiliary information info box.

Example 18: The method of any of the claims 14 to 17, wherein new information box is comprised in: a sample entry of the track, a sample table box, or in a track fragment box.

Example 19: The method of any of the claims 14 to 18 further comprising defining an entry count for providing a count of a number of entries of the one or more sample auxiliary information in the following array.

Example 20: The method of claim 19 further comprising defining an array for indicating an entry for the sample auxiliary information.

Example 21: The method of any of the claims 14 to 20, wherein the sample auxiliary information is protected using an encryption scheme.

Example 22: The method of any of the claims 14 to 21, wherein the sample auxiliary information is encoded with a content encoding method.

Example 23: The method of claim 22, wherein the content encoding method changes format of the sample auxiliary information data.

Example 24: The method of any of the claims 21 to 23, wherein when both the content encoding and protection are indicated for the sample auxiliary information, a reader needs to un-protect the sample auxiliary information data before the sample auxiliary information content encoding is decoded.

Example 25: The method of any of the claims 15 to 23, wherein the new information box comprises an array of entries, and wherein each entry comprises boxes comprising information needed to process the sample auxiliary information.

Example 26: The method of any of the claims 15 to 24 further comprising defining a protection box for providing an array of sample auxiliary information protection information for use by a corresponding sample auxiliary information in the new information box.

Example 27: A method comprising: receiving size information and offset information; wherein the size information comprises size of each sample auxiliary information of one or more sample auxiliary information comprised in a track; wherein offset information comprises offset of the each sample auxiliary information; and parsing the size information and the offset information.

Example 28: An apparatus comprising: at least one processor; and at least one memory storing instructions that, when executed by the at least one processor, cause the apparatus at least to perform: receiving size information and offset information, wherein the size information comprises size of each sample auxiliary information of one or more sample auxiliary information comprised in a track, and wherein offset information comprises offset of the each sample auxiliary information; and parsing the size information and the offset information.

Example 29: An apparatus comprising means for performing the methods as claimed in any of the claims 14 to 27.

Example 30: A computer readable medium comprising program instructions for performing methods as claimed in any of the claims 14 to 27.

Example 31: The computer readable medium of claim 30, wherein the computer readable medium comprises non-transitory computer readable medium.

### BRIEF DESCRIPTION OF THE DRAWINGS

The foregoing embodiments and other features are explained in the following description, taken in connection with the accompanying drawings, wherein:

FIG. 1 shows schematically an apparatus employing embodiments of the examples described herein.

FIG. 2 shows schematically a user equipment suitable for employing embodiments of the examples described herein.

FIG. 3 further shows schematically electronic devices employing embodiments of the examples described herein connected using wireless and wired network connections.

FIG. 4 is a block diagram illustrating a system in accordance with an example.

FIG. 5 is an example apparatus, which may be implemented in hardware, and is caused to, implement examples described herein.

FIG. 6 shows a representation of an example of non-volatile memory media used to store instructions that implement the examples described herein.

FIG. 7 is an example method performed with an encoder, based on the embodiments described herein.

FIG. 8 is an example method performed with a decoder, based on the embodiments described herein.

### DETAILED DESCRIPTION OF EXAMPLE EMBODIMENTS

The following acronyms and abbreviations that may be found in the specification and/or the drawing figures are defined as follows (the abbreviations may be appended with each other or with other characters using, e.g., a hyphen or dash (-), and may be case insensitive):
4CC four-character code
5G fifth generation cellular network technology
5GC 5G core network
a.k.a. also known as
AVC advanced video coding
CU coding unit
DSP digital signal processor
DU distributed unit
eNB (or eNodeB) evolved Node B (for example, an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, for example, the LTE radio access technology
F1 or F1-C interface between CU and DU control interface
gNB (or gNodeB) base station for 5G/NR, for example, a node providing NR user plane and control plane protocol terminations towards the UE, and connected via the NG interface to the 5GC
IEC International Electrotechnical Commission
IoT internet of things
ISO International Organization for Standardization
ISOBMFF ISO base media file format
JPEG joint photographic experts group
LTE long-term evolution
mdat MediaDataBox
MIME Multipurpose Internet Mail Extension
MME mobility management entity
moov MovieBox
MP4 file format for MPEG-4 Part 14 files
MPEG moving picture experts group
MPEG-2 H.222/H.262 as defined by the ITU
MPEG-4 audio and video coding standard for ISO/IEC 14496
ng or NG new generation
ng-eNB or NG-eNB new generation eNB
NR new radio (5G radio)
N/W or NW network
PDCP packet data convergence protocol
PHY physical layer
PNG portable network graphics
RAN radio access network
RFC request for comments
RLC radio link control
RRC radio resource control
RRH remote radio head
RU radio unit
Rx receiver
SDAP service data adaptation protocol
SGW serving gateway
SMF session management function
SPS sequence parameter set
SVC scalable video coding
S1 interface between eNodeBs and the EPC
trak TrackBox
Tx transmitter
UE user equipment
UICC Universal Integrated Circuit Card
UPF user plane function
URL uniform resource locator
X2 interconnecting interface between two eNodeBs in LTE network
Xn interface between two NG-RAN nodes

Some embodiments will now be described more fully hereinafter with reference to the accompanying drawings, in which some, but not all, embodiments may be shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms ‘data,’ ‘content,’ ‘information,’ and similar terms may be used interchangeably to refer to data capable of being transmitted, received and/or stored in accordance with embodiments of the present invention. Thus, use of any such terms should not be taken to limit the spirit and scope of embodiments.

Described herein is a method and apparatus for generic sample auxiliary information signaling.

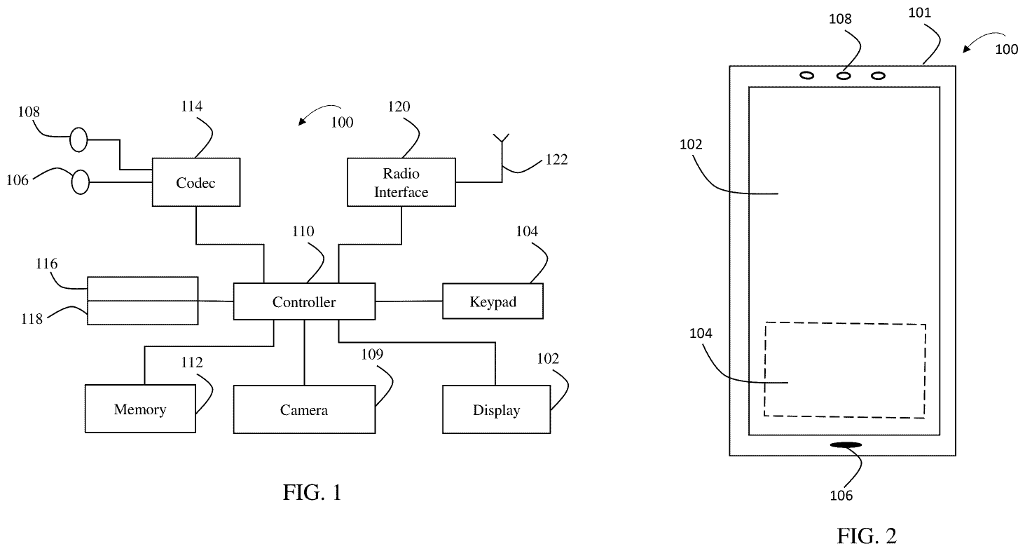

The following describes in detail a suitable apparatus and possible method for generic sample auxiliary information signaling according to embodiments. In this regard reference is first made to FIG. 1 and FIG. 2, where FIG. 1 shows an example block diagram of an electronic device or apparatus 100. The apparatus 100 may be an Internet of Things (IOT) apparatus configured to perform various functions, such as for example, gathering information by one or more sensors, receiving or transmitting information, analyzing information gathered or received by the apparatus, or the like. The apparatus may comprise a video coding system, which may incorporate a codec. FIG. 2 shows a layout of an apparatus according to an example embodiment. The elements of FIG. 1 and FIG. 2 are explained next.

The apparatus 100 may for example be a mobile terminal or user equipment of a wireless communication system, a sensor device, a tag, or other lower power device. However, it would be appreciated that embodiments of the examples described herein may be implemented within any electronic device or apparatus which may process data by neural networks.

The apparatus 100 may comprise a housing 101 for incorporating and protecting the device. The apparatus 100 further may comprise a display 102 in the form of a liquid crystal display. In other embodiments of the examples described herein the display may be any suitable display technology suitable to display an image or video. The apparatus 100 may further comprise a keypad 104. In other embodiments of the examples described herein any suitable data or user interface mechanism may be employed. For example, the user interface may be implemented as a virtual keyboard or data entry system as part of a touch-sensitive display.

The apparatus may comprise a microphone 106 or any suitable audio input which may be a digital or analog signal input. The apparatus 100 may further comprise an audio output device which in embodiments of the examples described herein may be any one of: an earpiece 108, speaker, or an analog audio or digital audio output connection. The apparatus 100 may also comprise a battery (or in other embodiments of the examples described herein the device may be powered by any suitable mobile energy device such as solar cell, fuel cell or clockwork generator). The apparatus 100 may further comprise a camera 109 capable of recording or capturing images and/or video. The apparatus 100 may further comprise an infrared port for short range line of sight communication to other devices. In other embodiments the apparatus 100 may further comprise any suitable short range communication solution such as for example a Bluetooth wireless connection or a USB/firewire wired connection.

The apparatus 100 may comprise a controller 110, processor or processor circuitry for controlling the apparatus 100. The controller 110 may be connected to memory 112 which in embodiments of the examples described herein may store both data in the form of image and audio data and/or may also store instructions for implementation on the controller 110. The controller 110 may further be connected to codec circuitry 114 suitable for carrying out coding and/or decoding of audio and/or video data or assisting in coding and/or decoding carried out by the controller.

The apparatus 100 may further comprise a card reader 118 and a smart card 116, for example a UICC and UICC reader for providing user information and being suitable for providing authentication information for authentication and authorization of the user at a network.

The apparatus 100 may comprise radio interface circuitry 120 connected to the controller and suitable for generating wireless communication signals for example for communication with a cellular communications network, a wireless communications system or a wireless local area network. The apparatus 100 may further comprise an antenna 122 connected to the radio interface circuitry 120 for transmitting radio frequency signals generated at the radio interface circuitry 120 to other apparatus(es) and/or for receiving radio frequency signals from other apparatus(es).

The apparatus 100 may comprise a camera capable of recording or detecting individual frames which are then passed to the codec circuitry 114 or the controller for processing. The apparatus may receive the video image data for processing from another device prior to transmission and/or storage. The apparatus 100 may also receive either wirelessly or by a wired connection the image for coding/decoding. The structural elements of apparatus 100 described above represent examples of means for performing a corresponding function.

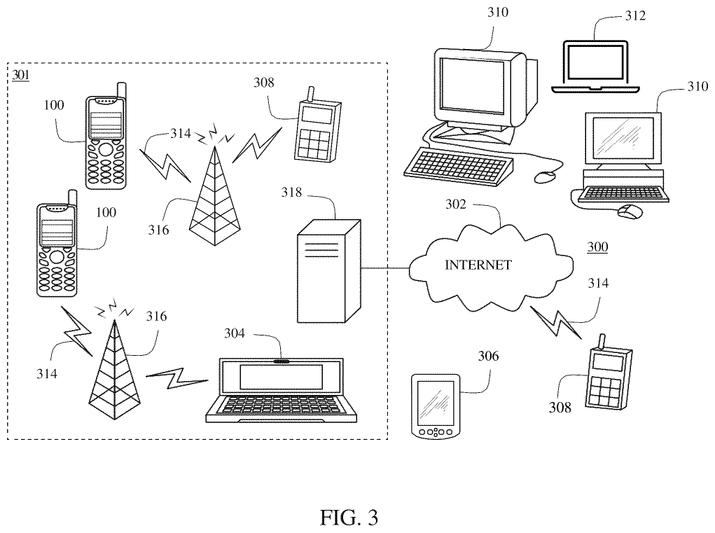

With respect to FIG. 3, an example of a system within which embodiments of the examples described herein can be utilized is shown. The system 300 comprises multiple communication devices which can communicate through one or more networks. The system 300 may comprise any combination of wired or wireless networks including, but not limited to a wireless cellular telephone network (such as a GSM, UMTS, CDMA, LTE, 4G, 5G network, etc.), a wireless local area network (WLAN) such as defined by any of the IEEE 802.x standards, a Bluetooth personal area network, an Ethernet local area network, a token ring local area network, a wide area network, and the Internet.

The system 300 may include both wired and wireless communication devices and/or apparatus 100 suitable for implementing embodiments of the examples described herein.

For example, the system shown in FIG. 3 shows a mobile telephone network 301 and a representation of the internet 302. Connectivity to the internet 302 may include, but is not limited to, long range wireless connections, short range wireless connections, and various wired connections including, but not limited to, telephone lines, cable lines, power lines, and similar communication pathways.

The example communication devices shown in the system 300 may include, but are not limited to, an electronic device or apparatus 100, a combination of a personal digital assistant (PDA) and a mobile telephone 304, a PDA 306, an integrated messaging device (IMD) 308, a desktop computer 310, a notebook computer 312, or a head-mounted apparatus. The head-mounted apparatus may be a head-mounted display (HMD), or glasses having a device such as a camera configured to encode and/or decode images and/or video. The apparatus 100 may be stationary or mobile when carried by an individual who is moving. The apparatus 100 may also be located in a mode of transport including, but not limited to, a car, a truck, a taxi, a bus, a train, a boat, an airplane, a bicycle, a motorcycle or any similar suitable mode of transport.

The embodiments may also be implemented in a set-top box; e.g., a digital TV receiver, which may/may not have a display or wireless capabilities, in tablets or (laptop) personal computers (PC), which have hardware and/or software to process neural network data, in various operating systems, and in chipsets, processors, DSPs and/or embedded systems offering hardware/software based coding.

Some or further apparatus may send and receive calls and messages and communicate with service providers through a wireless connection 314 to a base station 316. The base station 316 may be connected to a network server 318 that allows communication between the mobile telephone network 301 and the internet 302. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11, 3GPP Narrowband IOT and any similar wireless communication technology. A communications device involved in implementing various embodiments of the examples described herein may communicate using various media including, but not limited to, radio, infrared, laser, cable connections, and any suitable connection.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, from one or several senders (or transmitters) to one or several receivers.

The embodiments may also be implemented in so-called IoT devices. The Internet of Things (IoT) may be defined, for example, as an interconnection of uniquely identifiable embedded computing devices within the existing Internet infrastructure. The convergence of various technologies has and may enable many fields of embedded systems, such as wireless sensor networks, control systems, home/building automation, etc. to be included in the Internet of Things (IoT). In order to utilize the Internet IoT devices are provided with an IP address as a unique identifier. IoT devices may be provided with a radio transmitter, such as a WLAN or Bluetooth transmitter or a RFID tag. Alternatively, IoT devices may have access to an IP-based network via a wired network, such as an Ethernet-based network or a power-line connection (PLC).

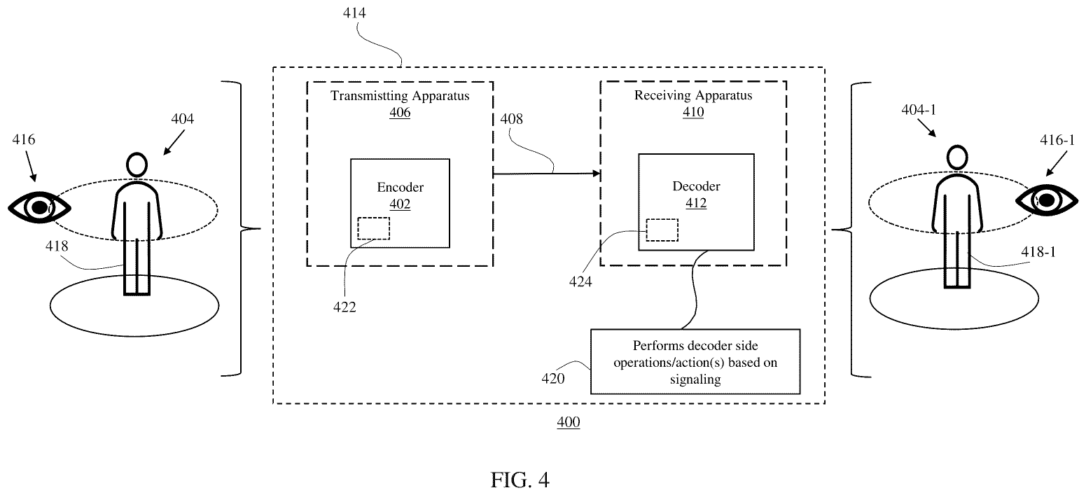

FIG. 4 is a block diagram illustrating a system or apparatus 400 in accordance with several examples. In an example, the encoder 402 is used to encode an image or video from the scene 404, and the encoder 402 is implemented in a transmitting apparatus 406. The encoder 402 produces a bitstream 408 comprising signaling that is received by the receiving apparatus 410, which implements a decoder 412. The encoder 402 sends the bitstream 408 that comprises the herein described signaling. The decoder 412 forms the image or video for the scene 404-1, and the receiving apparatus 410 would present this to the user, e.g., via a smartphone, television, or projector among many other options.

In some examples, the transmitting apparatus 406 and the receiving apparatus 410 are at least partially within a common apparatus, and for example, are located within a common housing 414. In other examples the transmitting apparatus 406 and the receiving apparatus 410 are at least partially not within a common apparatus and have at least partially different housings. Therefore in some examples, the encoder 402 and the decoder 412 are at least partially within a common apparatus, and for example are located within a common housing 414. For example, the common apparatus comprising the encoder 402 and decoder 412 implements a codec. In other examples, the encoder 402 and the decoder 412 are at least partially not within a common apparatus and have at least partially different housings, but when together still implement a codec.

In some examples, 3D media from the capture (e.g., volumetric capture) at a viewpoint 416 of the scene 404, which includes a person 418) is converted via projection to a series of 2D representations with occupancy, geometry, attributes and/or displacements. Additional atlas information is also included in the bitstream to enable inverse reconstruction. For decoding, the received bitstream 408 is separated into its components with atlas information; occupancy, geometry, displacement, and attribute 2D representations. A 3D reconstruction is performed to reconstruct the scene 404-1 created looking at the viewpoint 416-1 with a “reconstructed” person 418-1. The “-1” are used to indicate that these are reconstructions of the original. As indicated at 420, the decoder 412 performs an operation(s) or action(s) based on the received signaling.

Encoding 422 performs encoding of sample auxiliary information based on the examples described herein. Decoding 424 performs decoding of sample auxiliary information, based on the examples described herein.

Having thus introduced a suitable but non-limiting technical context for the practice of the example embodiments of the present disclosure, example embodiments will now be described in detail.

Features as described herein may generally relate, for example, to the ISO base media file format (ISOBMFF).

### ISO Base Media File Format

Available media file format standards include International Standards Organization (ISO) base media file format (ISO/IEC 14496-12, which may be abbreviated ISOBMFF), Moving Picture Experts Group (MPEG)-4 file format (ISO/IEC 14496-14, also known as the MP4 format), and the file format for NAL (Network Abstraction Layer) unit structured video (ISO/IEC 14496-15).

Some concepts, structures, and specifications of ISOBMFF are described below as an example of a container file format, based on which some embodiments may be implemented. The aspects of the disclosure are not limited to ISOBMFF, but rather the description is given for one possible basis on top of which at least some embodiments may be partly or fully realized.

A basic building block in the ISO base media file format is called a box. Each box has a header and a payload. The box header indicates the type of the box and the size of the box in terms of bytes. Box type is typically identified by an unsigned 32-bit integer, interpreted as a four character code (4CC). A box may enclose other boxes, and the ISO file format specifies which box types are allowed within a box of a certain type. Furthermore, the presence of some boxes may be mandatory in each file, while the presence of other boxes may be optional. Additionally, for some box types, it may be allowable to have more than one box present in a file. Thus, the ISO base media file format may be considered to specify a hierarchical structure of boxes.

In files conforming to the ISO base media file format, the media data may be provided in one or more instances of MediaDataBox (‘mdat’) and the MovieBox (‘moov’) may be used to enclose the metadata for timed media. In some cases, for a file to be operable, both of the ‘mdat’ and ‘moov’ boxes may be required to be present. The ‘moov’ box may include one or more tracks, and each track may reside in one corresponding TrackBox (‘trak’). Each track is associated with a handler, identified by a four-character code, specifying the track type. Video, audio, and image sequence tracks can be collectively called media tracks, and they include an elementary media stream. Other track types comprise hint tracks and timed metadata tracks.

Tracks comprise samples, such as audio or video frames. For video tracks, a media sample may correspond to a coded picture or an access unit.

A media track refers to samples (which may also be referred to as media samples) formatted according to a media compression format (and its encapsulation to the ISO base media file format). A hint track refers to hint samples, including cookbook instructions for constructing packets for transmission over an indicated communication protocol. A timed metadata track may refer to samples describing referred media and/or hint samples.

The ‘trak’ box includes in its hierarchy of boxes the SampleDescriptionBox, which gives detailed information about the coding type used, and any initialization information needed for that coding. The SampleDescriptionBox includes an entry-count and as many sample entries as the entry-count indicates. The format of sample entries is track-type specific but derived from generic classes (e.g., VisualSampleEntry, AudioSampleEntry). Which type of sample entry form is used for derivation of the track-type specific sample entry format is determined by the media handler of the track.

A sample entry may comprise a configuration box, which itself may comprise a configuration record. The configuration record may comprise information that may be used to configure a decoder instance for decoding the samples mapped to the sample entry.

A sample table includes all the time and data indexing of the media samples in a track. Using the tables here, it is possible to locate samples in time, determine their type (e.g., I-frame or not), and determine their size, container, and offset into that container.

When the track that includes the SampleTableBox, refers to no data, then the SampleTableBox does not need to include any sub-boxes (this is not a very useful media track).

When the track that the SampleTableBox is contained in, refers to data, then the following sub-boxes are required: SampleDescriptionBox, SampleSizeBox (or CompactSampleSizeBox), Sample ToChunkBox, and Chunk OffsetBox (or ChunkLargeOffsetBox). Further, the SampleDescriptionBox shall include at least one entry. A SampleDescriptionBox is required because it includes the data reference index field, which indicates which DataEntry to use to retrieve the media samples. Without the SampleDescriptionBox, it is not possible to determine where the media samples are stored.

The syntax of SampleTableBox in ISOBMFF is as follows:

aligned(8) class SampleTableBox extends Box(‘stbl’) {
}

A SampleSizeBox includes the sample count and a table giving the size in bytes of each sample. This allows the media data itself to be unframed. The total number of samples in the media is always indicated in the sample count. There are two variants of the sample size box. The first variant has a fixed size 32-bit field for representing the sample sizes; it permits defining a constant size for all samples in a track. The second variant permits smaller size fields, to save space when the sizes are varying but small. One of these boxes shall be present; the first version is preferred for maximum compatibility.

A sample size of zero is not prohibited in general, but it must should be valid and defined for the coding system, as defined by the sample entry, that the sample belongs to.

The syntax of SampleSizeBox in ISOBMFF is as follows:

```
aligned(8) class SampleSizeBox extends FullBox(‘stsz’, version = 0, 0) {
  unsigned int(32) sample_size;
  unsigned int(32) sample_count;
  if (sample_size==0) {
    for (i=1; i <= sample_count; i++) {
    unsigned int(32) entry_size;
    }
  }
}
```

The semantics of SampleSizeBox structure in ISOBMFF is as follows:
version is an integer that specifies the version of this box;
sample_size is integer specifying the default sample size. When all the samples are the same size, this field includes that size value. When this field is set to 0, then the samples have different sizes, and those sizes are stored in the sample size table. When this field is not 0, it specifies the constant sample size, and no array follows:
sample_count is an integer that gives the number of samples in the track; when sample-size is 0, then it is also the number of entries in the following table.
entry_size is an integer specifying the size of a sample, indexed by its number.

The syntax of CompactSampleSizeBox in ISOBMFF is as follows:

| aligned(8) class CompactSampleSizeBox | |
|---|---|
| extends FullBox(‘stz2’, version = 0, 0) { | |
| unsigned int(24) | reserved = 0; |
| unsigned int(8) | field_size; |
| unsigned int(32) | sample_count; |

```
  for (i=1; i <= sample_count; i++) {
    unsigned int(field_size) entry_size;
  }
}
```

The semantics of CompactSampleSizeBox structure in ISOBMFF is as follows:
version is an integer that specifies the version of this box;
field_size is an integer specifying the size in bits of the entries in the following table; it shall take the value 4, 8 or 16. When the value 4 is used, then each byte includes two values:
entry[i]<<4+entry[i+1]; when the sizes do not fill an integral number of bytes, the last byte is padded with zeros.
sample_count is an integer that gives the number of entries in the following table
entry_size is an integer specifying the size of a sample, indexed by its number.

The ISO Base Media File Format includes three mechanisms for timed metadata that can be associated with particular samples: sample groups, timed metadata tracks, and sample auxiliary information. A derived specification may provide similar functionality with one or more of these three mechanisms.

A sample grouping in the ISO base media file format and its derivatives, such as ISO/IEC 14496-15, may be defined as an assignment of each sample in a track to be a member of one sample group, based on a grouping criterion. A sample group in a sample grouping is not limited to being contiguous samples and may include non-adjacent samples. As there may be more than one sample grouping for the samples in a track, each sample grouping may have a type field to indicate the type of grouping. Sample groupings may be represented by two linked data structures: (1) a SampleToGroupBox (sbgp box) represents the assignment of samples to sample groups; and (2) a SampleGroupDescriptionBox (sgpd box) includes a sample group entry for each sample group describing the properties of the group. There may be multiple instances of the SampleToGroupBox and SampleGroupDescriptionBox based on different grouping criteria. These may be distinguished by a type field used to indicate the type of grouping. SampleToGroupBox may comprise a grouping_type_parameter field that can be used e.g., to indicate a sub-type of the grouping.

Per-sample sample auxiliary information may be stored anywhere in the same file as the sample data itself; for self-contained media files, this is typically in a MediaDataBox or a box from a derived specification. It is stored either (a) in multiple chunks, with the number of samples per chunk, as well as the number of chunks, matching the chunking of the primary sample data or (b) in a single chunk for all the samples in a movie sample table (or a movie fragment). The Sample Auxiliary Information for all samples contained within a single chunk (or track run) is stored contiguously (similarly to sample data).

Sample Auxiliary Information, when present, is always stored in the same file as the samples to which it relates as they share the same data reference (‘dref’) structure. However, this data may be located anywhere within this file, using auxiliary information offsets (‘saio’) to indicate the location of the data.

Whether sample auxiliary information is permitted or required may be specified by the brands or the coding format in use. The format of the sample auxiliary information is determined by aux_info_type. When aux_info_type and aux_info_type_parameter are omitted then the implied value of aux_info_type is either (a) in the case of transformed content, such as protected content, the scheme_type included in the ProtectionSchemeInfoBox or ScrambleSchemeInfoBox, or otherwise (b) the sample entry type. In the case of tracks including multiple transformations, aux_info_type and aux_info_type_parameter shall not be omitted. The default value of the aux_info_type_parameter is 0. Some values of aux_info_type may be restricted to be used only with particular track types. A track may have multiple streams of sample auxiliary information of different types. The types are managed according to Annex D.

While aux_info_type determines the format of the auxiliary information, several streams of auxiliary information having the same format may be used when their value of aux_info_type_parameter differs. The semantics of aux_info_type_parameter for a particular aux_info_type value shall be specified along with specifying the semantics of the particular aux_info_type value and the implied auxiliary information format. This box provides the size of the auxiliary information for each sample. For each instance of this box, there shall be a matching Sample AuxiliaryInformationOffsetsBox with the same values of aux_info_type and aux_info_type_parameter, providing the offset information for this auxiliary information.

The syntax of SampleAuxiliaryInformationSizesBox in ISOBMFF is given below.

```
aligned(8) class SampleAuxiliaryInformationSizesBox
  extends FullBox(‘saiz’, version = 0, flags)
{
  if (flags & 1) {
    unsigned int(32) aux_info_type;
    unsigned int(32) aux_info_type_parameter;
  }
  unsigned int(8) default_sample_info_size;
  unsigned int(32) sample_count;
  if (default_sample_info_size == 0) {
    unsigned int(8) sample_info_size[ sample_count ];
  }
}
```

Where the different fields are defined as follows.

aux_info_type is an integer that identifies the type of the sample auxiliary information. At most one occurrence of this box with the same values for aux_info_type and aux_info_type_parameter shall exist in the including box.

aux_info_type_parameter identifies the “stream” of auxiliary information having the same value of aux_info_type and associated to the same track. The semantics of aux_info_type_parameter are determined by the value of aux_info_type.

default_sample_info_size is an integer specifying the sample auxiliary information size for the case where all the indicated samples have the same sample auxiliary information size. When the size varies then this field shall be zero.

sample_count is an integer that gives the number of samples for which a size is defined. For a SampleAuxiliaryInformationSizesBox appearing in the SampleTableBox this shall be the same as, or less than, the sample_count within the SampleSizeBox or CompactSampleSizeBox. For a SampleAuxiliaryInformationSizesBox appearing in a TrackFragmentBox this shall be the same as, or less than, the sum of the sample_count entries within the TrackRunBoxes of the track fragment. When this is less than the number of samples, then auxiliary information is supplied for the initial samples, and the remaining samples have no associated auxiliary information.

sample_info_size gives the size of the sample auxiliary information in bytes. This may be zero to indicate samples with no associated auxiliary information.

The SampleAuxiliaryInformationOffsetsBox provides the position information for the sample auxiliary information, in a way similar to the chunk offsets for sample data.

The syntax of SampleAuxiliaryInformationOffsetsBox in ISOBMFF is as follows:

```
aligned(8) class SampleAuxiliaryInformationOffsetsBox
  extends FullBox(‘saio’, version, flags)
{
  if (flags & 1) {
    unsigned int(32) aux_info_type;
    unsigned int(32) aux_info_type_parameter;
  }
  unsigned int(32) entry_count;
  if ( version == 0 ) {
    unsigned int(32) offset[ entry_count ];
  }
  else {
    unsigned int(64) offset[ entry_count ];
  }
}
```

aux_info_type and aux_info_type_parameter are defined as in the Sample Auxiliary InformationSizesBox

entry_count gives the number of entries in the following table. For a SampleAuxiliaryInformationOffsetsBox appearing in a Sample Table Box this shall be equal to one or to the value of the entry_count field in the ChunkOffsetBox or ChunkLargeOffsetBox. For a SampleAuxiliaryInformationOffsetsBox appearing in a TrackFragmentBox, this shall be equal to one or to the number of TrackRunBoxes in the TrackFragmentBox.

offset gives the position in the file of the Sample Auxiliary Information for each Chunk or Track Fragment Run. When entry_count is one, then the Sample Auxiliary Information for all Chunks or Runs is contiguous in the file in chunk or run order. When in the SampleTableBox, the offsets are relative to the same base offset as derived for the respective samples through the data_reference_index of the sample entry referenced by the samples. In a TrackFragmentBox, this value is relative to the base offset established by the TrackFragmentHeaderBox in the same track fragment.

When sample auxiliary information is present in the MovieFragmentBox, the offsets in the SampleAuxiliaryInformationOffsetsBox are treated the same as the data_offset in the TrackRunBox, that is, they are relative to any base data offset established for that track fragment.

When only one offset is provided, then the Sample Auxiliary Information for all the track runs in the fragment is stored contiguously, otherwise exactly one offset shall be provided for each track run.

When the field default_sample_info_size is non-zero in one of these boxes, then the size of the auxiliary information is constant for the identified samples.

In addition, when:
this box is present in the MovieBox,
and default_sample_info_size is non-zero in the box in the MovieBox,
and the Sample AuxiliaryInformationSizesBox is absent in a movie fragment,

then the auxiliary information has this same constant size for every sample in the movie fragment also; it is then not necessary to repeat the box in the movie fragment.

The ProtectionSchemeInfoBox includes the information required both to understand the encryption transform applied and its parameters, and also to find other information such as the kind and location of the key management system. It also documents the original (unencrypted) format of the media. The ProtectionSchemeInfoBox is a container Box. It is mandatory in a sample entry that uses a code indicating a protected stream.

When used in a protected sample entry, this box may include the OriginalFormatBox to document the original format. At least one of the following signalling methods may be used to identify the protection applied:
MPEG-4 systems with IPMP: no other boxes, when IPMP descriptors in MPEG-4 systems streams are used; or
Scheme signalling: a SchemeTypeBox and SchemeInformationBox, when these are used (either both shall occur, or neither).

At least one ProtectionSchemeInfoBox shall occur in a protected sample entry. When more than one occurs, they are equivalent, alternative, descriptions of the same protection. Readers should choose one to process.

The syntax of ProtectionSchemeInfoBox in ISOBMFF is as follows:

aligned(8) class ProtectionSchemeInfoBox(fmt) extends Box(‘sinf’) {

| OriginalFormatBox(fmt) | original_format; | |
|---|---|---|
| SchemeTypeBox | scheme_type_box; | // optional |
| SchemeInformationBox | info; | // optional |

}

The OriginalFormatBox includes the four character code of the original un-transformed sample description.

The syntax of OriginalFormatBox in ISOBMFF is as follows:

```
aligned(8) class OriginalFormatBox(codingname) extends Box (‘frma’) {
  unsigned int(32) data_format = codingname;
    // format of decrypted, encoded data (in case of protection)
    // or un-transformed sample entry (in case of restriction
    // and complete track information)
}
```

data_format is the four character code of the original un-transformed sample entry (e.g. ‘mp4v’ if the stream includes protected or restricted MPEG-4 visual material).

The Scheme TypeBox identifies the protection or restriction scheme.

The syntax of SchemeTypeBox in ISOBMFF is as follows:

```
aligned(8) class SchemeTypeBox extends FullBox(‘schm’, 0, flags) {
  unsigned int(32) scheme_type; // 4CC identifying the scheme
  unsigned int(32) scheme_version; // scheme version
  if (flags & 0x000001) {
    utf8string scheme_uri; // browser uri
  }
}
```

scheme_type is the code defining the protection or restriction scheme, normally expressed as a four character code.

scheme_version is the version of the scheme (used to create the content).

scheme_URI is an absolute URI allowing for the option of directing the user to a web-page if they do not have the scheme installed on their system.

The SchemeInformationBox is a container Box that is only interpreted by the scheme being used. Any information the encryption or restriction system needs is stored here. The content of this box is a series of boxes whose type and format are defined by the scheme declared in the SchemeTypeBox.

The syntax of SchemeInformationBox in ISOBMFF is as follows:

aligned(8) class SchemeInformationBox extends Box(‘schi’) {
Box scheme_specific_data[ ];
}

Files conforming to the ISOBMFF may include any non-timed objects, referred to as items, meta items, or metadata items, in a meta box (four-character code: ‘meta’). While the name of the meta box refers to metadata, items can generally include metadata or media data. The meta box may reside at the top level of the file, within a movie box (four-character code: ‘moov’), and within a track box (four-character code: ‘trak’), but at most one meta box may occur at each of the file level, movie level, or track level. The meta box may be required to include a ‘hdlr’ box indicating the structure or format of the ‘meta’ box contents. The meta box may list and characterize any number of items that can be referred and each one of them can be associated with a file name and are uniquely identified with the file by item identifier (item_id) which is an integer value. The metadata items may be for example stored in the ‘idat’ box of the meta box or in an ‘mdat’ box or reside in a separate file. When the metadata is located external to the file then its location may be declared by the DataInformationBox (four-character code: ‘dinf’). In the specific case that the metadata is formatted using extensible Markup Language (XML) syntax and is required to be stored directly in the MetaBox, the metadata may be encapsulated into either the XMLBox (four-character code: ‘xml’) or the BinaryXMLBox (four-character code: ‘bxml’). An item may be stored as a contiguous byte range, or it may be stored in several extents, each being a contiguous byte range. In other words, items may be stored fragmented into extents, e.g., to enable interleaving. An extent is a contiguous subset of the bytes of the resource. The resource can be formed by concatenating the extents.

MPEG-5 Part 2 Low Complexity Enhancement Video Coding (LCEVC) is published as ISO/IEC 23094-2. LCEVC works by encoding a lower resolution (and potentially also lower bit depth) version of a source video using any existing codec (the “base codec”) and then coding the differences between the lower resolution video and the full resolution source, up to mathematically lossless coding if needed, using a different compression method (the “enhancement”). This enhancement is achieved by a combination of processing an input video at a lower resolution with an existing single-layer codec, and using a simple and small set of highly specialized tools to correct impairments, upscale, and add details to the processed video.

In an example, a first encoded bitstream encoded with a first coding standard/method, and a second encoded bitstream(s) encoded with a second coding standard/method may be used as input to produce an encapsulated file with one track. The one track may comprise the first encoded bitstream and the second encoded bitstream(s). The file may also include an indication that the first encoded bitstream is encapsulated in the samples of the track, and the second encoded bitstream is encapsulated in the sample auxiliary information of the track.

In an example, an encapsulated file with at least one track may be used as input to produce a first encoded bitstream encoded with a first coding standard/method, and a second encoded bitstreams encoded with second coding standard/method. The at least one track may comprise a first encoded bitstream and a second encoded bitstream(s). The file may also include an indication that the first encoded bitstream is encapsulated in the samples of the track and the second encoded bitstream is encapsulated in the sample auxiliary information of the track.

In an example, the samples of the base track may contain the data related to the base codec, and the data related to second codec (for example, LCEVC). The data related to the second codec may be carried as part of the sample auxiliary information related to the samples of the base track.

### Signaling Information about Sample auxiliary Information

A track may include one or more sample auxiliary information, the size and offset of each sample auxiliary information in the track is defined by the corresponding SampleAuxiliaryInformationSizesBox and SampleAuxiliaryInformationOffsetsBox respectively.

In an embodiment, when a track includes two or more distinct sample auxiliary information then all the corresponding SampleAuxiliaryInformationSizesBox and the SampleAuxiliaryInformationOffsetsBox within the SampleTableBox or TrackFragmentBox of the track should always contain both the aux_info_type and the aux_info_type parameter.

In an embodiment, when a track includes two or more distinct sample auxiliary information, and the track contains multiple SampleAuxiliaryInformationSizesBoxes and SampleAuxiliaryInformationOffsetsBoxes within the SampleTableBox or TrackFragmentBox and if two or more of the SampleAuxiliaryInformationSizesBoxes and SampleAuxiliaryInformationOffsetsBoxes does not contain both the aux_info_type and the aux_info_type parameter then the reader does not process any of the SampleAuxiliaryInformationSizesBoxes and the SampleAuxiliaryInformationOffsetsBoxes without the aux_info_type and the aux_info_type parameter.

In an embodiment, when a track includes two or more distinct sample auxiliary information, and the track contains multiple SampleAuxiliaryInformationSizesBoxes and SampleAuxiliaryInformationOffsetsBoxes within the SampleTableBox or TrackFragmentBox; and if one of the Sample Auxiliary InformationSizesBoxes and one of the SampleAuxiliaryInformationOffsetsBoxes does not contain both the aux_info_type and the aux_info_type parameter then the reader concludes the value of aux_info_type is either (a) in the case of transformed content, such as protected content, the scheme_type included in the ProtectionSchemeInfoBox or ScrambleSchemeInfoBox of the SampleEntry, or otherwise (b) the sample entry type.

In an embodiment, when a track includes one or more distinct sample auxiliary information data, the presence/information of sample auxiliary information data may be defined using a new box called SampleAuxiliaryInformationBox or SAIBox or any other suitable name with a suitable 4cc value for example ‘saib’ may be used.

In an embodiment, the SAIBox may be present in the sample entry of a track. In an alternate embodiment, the SAIBox may be present in the SampleTableBox or in TrackFragmentBox.

In an embodiment, when the SAIBox (used to document information about one or more distinct sample auxiliary information data) is present in the SampleTableBox of the track and if the track includes two or more SampleEntries within the SampleDescriptionBox; then each sample auxiliary information data documented within the SAIBox will have a mapping indicating to which of the SampleEntries does the sample auxiliary information data belong to. The mapping from sample auxiliary information data documented within the SAIBox to a specific SampleEntry may be done by having a parameter within the SAIBox for example the index of the SampleEntry within the SampleDescriptionBox.

In an example embodiment, the SAIBox structure may be defined as follows:

```
aligned(8) class SAIBox extends FullBox(‘saib’, version, 0)
{
  if (version == 0) {
    unsigned int(16) entry_count;
  } else {
    unsigned int(32) entry_count;
  }
  SAIInfoBox SAI_info_entry[ entry_count ];
}
```

In an embodiment, entry_count provides a count of the number of entries (count of number of Sample auxiliary information) in the following array.

In an embodiment, SAI_info_entry[i] indicates the SAIInfoBox for the ith sample auxiliary information for which the information is present in the SAIBox.

In an embodiment, the SAIBox provides information about selected sample auxiliary information. In an embodiment, there may be other sample auxiliary information data within the track not documented by SAIBox, for example sample auxiliary information data for sample encryption.

In an embodiment, the sample auxiliary information data may be optionally protected using a known encryption scheme and may be optionally encoded with a content encoding method, where the content encoding may have changed the format of the sample auxiliary information data.

In an embodiment, when both content encoding and protection are indicated for a sample auxiliary information, a reader should first un-protect the sample auxiliary information data, and then decode the sample auxiliary information content encoding.

In an embodiment, the SAIBox contains an array of entries, and each entry may be formatted as a box.

In an embodiment, the box formatted entries of SAIBox may be defined as sample auxiliary information Info box or SAIInfoBox or any other suitable name may be used.

In an embodiment, the array of entries in SAIBox may be sorted by increasing or decreasing sai_ID values, where sai_ID value is present within each of the entry records (within each SAIInfoBox).

In an alternate embodiment, the array of entries in SAIBox may be unsorted (no sai_ID in the entry records or sai_ID values not used for array entries).

In an alternate embodiment, the SAIBox includes an array of entries, and each entry may include boxes including information needed to process the sample auxiliary information, for example ProtectionSchemeInfoBox when the ith sample auxiliary information is protected. Other configuration boxes needed to process the sample auxiliary information data may also be present.

In an alternate example embodiment, the SAIBox structure may be defined as follows:

```
aligned(8) class SAIBox extends FullBox(‘saib’, version, 0)
{
  if (version == 0) {
    unsigned int(16) entry_count;
  } else {
    unsigned int(32) entry_count;
  }
  for(i=0; i< entry_count;i++) {
    SAIInfoBox SAI_info_entry[ i ];
    // optional boxes needed to decode the sample auxiliary information
    OtherSAIConfigurationBoxes[ ];
}
}
```

In an embodiment, the example syntax of SAIInfoBox is defined as below.

```
aligned(8) class SAIInfoExtension(unsigned int(32) extension_type)
{
}
aligned(8) class SAIInfoBox extends FullBox(‘saii’, version, flags)
{
  unsigned int(32) sai_ID;
  unsigned int(32) aux_info_type;
  unsigned int(32) aux_info_type_parameter;
  unsigned int(1) sai_protection_present_flag;
  unsigned int(1) sai_content_encoding_present_flag;
  unsigned int(1) sai_info_extension_present_flag;
  unsigned int(5) reserved = 0;
  if(sai_protection_present_flag) {
    unsigned int(16) sai_protection_index;
  }
  if (aux_info_type == ‘mime’) {
    utf8string content_type;
  }
  else if (aux_info_type == ‘uri ’) {
    utf8string encoding_uri_type;
  }
  If(sai_content_encoding_present_flag) {
    utf8string content_encoding; //optional
  }
  if(sai_info_extension_present_flag) {
    unsigned int(32) extension_type;
    SAIInfoExtension(extension_type); //optional
  }
}
```

In an embodiment, the SAIInfoBox may contain the sai_ID which indicates the ID of the sample auxiliary information for which the following information is defined.

In an embodiment, the sample auxiliary information data may be protected.

In an embodiment, when sai_protection_present_flag is set to 1 then SAIInfoBox contains sai_protection_index

In an embodiment, when sai_protection_present_flag is set to 0 then SAIInfoBox does not contains sai_protection_index

In an alternate embodiment, when sai_protection_present_flag is set to 1 in SAIInfoBox then it indicates that the sample auxiliary information data is protected, and the protection related information is present in the corresponding entry within the SAIBox (in this case the SAIInfoBox does not contain sai_protection_index and a ProtectionSchemeInfoBox is present in the ith entry of the SAIBox)

In an alternate embodiment, when sai_protection_present_flag is set to 0 in SAIInfoBox then it indicates that the sample auxiliary information data is not protected.

In an embodiment, sai_protection_index contains either 0 for an unprotected sample auxiliary information data, or the index, with value 1 indicating the first entry, into the SAIProtectionBox defining the protection applied to this sample auxiliary information data (the first box in the SAIProtectionBox has the index 1).

In an embodiment, the sample auxiliary information data may be content encoded with a certain coding format.

In an embodiment, when sai_content_encoding_present_flag is set to 1 then SAIInfoBox includes content encoding information for the sample auxiliary information

In an embodiment, when sai_content_encoding_present_flag is set to 0 then SAIInfoBox does not include any content encoding information for the sample auxiliary information

In an embodiment, the content_encoding in the SAIInfoBox indicates that the sample auxiliary information is encoded and needs to be decoded before interpreted. The values are as defined for Content-Encoding for HTTP/1.1. Some possible values are “gzip”, “compress” and “deflate”. An empty string indicates no content encoding.

In an embodiment, the sample auxiliary information data is stored after the content encoding has been applied.

In an embodiment, the SAIInfoBox may allow extension mechanism to include any additional information related to the sample auxiliary information.

In an embodiment, when sai_info_extension_present_flag is set to 1 then SAIInfoBox contains sample auxiliary information info extension or SAIInfoExtension of a given extension_type.

In an embodiment, when sai_info_extension_present_flag is set to 0 then SAIInfoBox does not contain any sample auxiliary information info extension or SAIInfoExtension of a given extension_type.

In an embodiment, the SAIInfoBox may include extension_type which is a four-character code that identifies the extension fields of the SAI information entry.

In an embodiment, when no extension is desired to SAIInfoBox, the box may terminate without the extension_type field and the extension; when, in addition, content_encoding is not desired, that field also may be absent, and the box terminate before it. When an extension is desired without an explicit content_encoding, a single null byte, signifying the empty string, shall be supplied for the content_encoding, before the indication of extension_type.

In alternate embodiment, the flags (sai_protection_present_flag, an sai_content_encoding_present_flag, sai_info_extension_present_flag) defined in SAIInfoBox may be signalled using the version or flag fields of the SAIInfoBox fullbox structure parameters.

In an example embodiment, the sample auxiliary information data may be used for presentation with the sample data of the data. In such a case the SAIInfoBox for the said sample auxiliary information may carry information (for example a sai_in_presentation_flag when set to 1 indicates that the said sample auxiliary information is used for presentation; sai_in_presentation_flag when set to 0 indicates that the said sample auxiliary information is not used for presentation) indicating that the said sample auxiliary information is used for presentation.

In another alternate embodiment, the SAIBox is only a container box without any parameters, it only contains other boxes needed to process one or more sample auxiliary information. The syntax of this embodiment may be defined as follows:

aligned(8) class SAIBox extends Box(‘saib’)
{
}

In an embodiment, the SAIBox carries information about only a single sample auxiliary information and if multiple sample auxiliary information data is present, then multiple SAIBoxes are used within the parent container box to carry information about two or more sample auxiliary information (for example multiple SAIBoxes are present in the SampleTableBox).

In an embodiment, if the SAIBox is a container box without any parameters and it carries information about multiple sample auxiliary information, then a new container box is defined called SAIDescriptionBox (any other suitable name and 4cc may be used) with 4cc ‘sdes’ which contains information about a single sample auxiliary information.

In an embodiment, there should be at least one SAIDescriptionBox in SAIBox.

In an example embodiment, the structure of SAIDescriptionBox is defined below.

aligned(8) class SAIDescriptionBox extends Box(‘said’)
{
}

In an embodiment, the SAIDescriptionBox contains the SAIInfoBoxes for a specific single sample auxiliary information. The content of SAIInfoBoxes is as defined above.

In an embodiment, if the sample auxiliary information specified by the SAIDescriptionBox is protected; then allow the ProtectionSchemeInfoBoxes to be present inside SAIDescriptionBox. The SAIDescriptionBox contains the ProtectionSchemeInfoBoxes which defines the scheme type used for encrypting the sample auxiliary information specified in SAIDescriptionBox. In this case the SAIInfoBox structure within the SAIDescriptionBox does not contain the sai_protection_index.

### Protection of Sample Auxiliary Information

In an embodiment, a new sample auxiliary information protection box or SAIProtectionBox is defined with a 4cc value equal to spro or any other suitable value may be used.

In an embodiment, the SAIProtectionBox provides an array of SAI protection information, for use by the corresponding sample auxiliary information in the SAIBox (when the SAIBox is not a container box and includes entry_count parameter).

In an embodiment, the SAIProtectionBox is present at the same level as the SAIBox (when the SAIBox is not a container box and includes entry_count parameter).

In an alternate embodiment, the SAIProtectionBox is present within the SAIBox.

In an embodiment, allow the ProtectionSchemeInfoBoxes to be present in the SAIProtectionBox.

In an alternate embodiment, allow the ProtectionSchemeInfoBoxes to be present in the SAIInfoBox.

In another alternate embodiment, allow the ProtectionSchemeInfoBox to be present as part of the ith loop in the SAIBox.

In an example embodiment, one of the OtherSAIConfigurationBoxes in the ith loop of the SAIBox is the ProtectionSchemeInfoBox indicating that the sample auxiliary information signalled within the ith loop of the SAIBox is protected as indicated by the respective ProtectionSchemeInfoBox.

In an embodiment, the ProtectionSchemeInfoBoxes may not include an OriginalFormatBox when present in an SAIProtectionBox.

In an embodiment, the ProtectionSchemeInfoBoxes may not include an OriginalFormatBox when present in an SAIInfoBox.

In an embodiment, the ProtectionSchemeInfoBoxes may include an OriginalFormatBox documenting the original format of the sample auxiliary information before the protection scheme as defined by the scheme_type was applied to the sample auxiliary information data.

In an example embodiment, the syntax of SAIProtectionBox is defined below:

```
aligned(8) class SAIProtectionBox
  extends FullBox(‘spro’, version, flags)
{
  unsigned int(16) protection_count;
  for (i=1; i<=protection_count; i++) {
    ProtectionSchemeInfoBox protection_information;
  }
}
```

protection_count provides a count of the number of entries (count of number of Sample auxiliary information protection information) in the array.

In an embodiment, both the samples of the track and one or more sample auxiliary information data may be protected. The corresponding SampleAuxiliaryInformationSizesBoxes and SampleAuxiliaryInformationOffsetsBoxes which carry the encryption related data for both the samples of the track and one or more sample auxiliary information data should have distinct combination of (aux_info_type and aux_info_type_parameter) pair.

In an embodiment, when both the samples of the track and one or more sample auxiliary information data are protected. If the corresponding SampleAuxiliaryInformationSizesBoxes and SampleAuxiliaryInformationOffsetsBoxes which carry the encryption related data for both the samples of the track and one or more sample auxiliary information data have the same combination of (aux_info_type and aux_info_type_parameter) pair, then both the samples of the track and one or more sample auxiliary information data share the same encryption related parameters.

### Dynamic Information for Sample Auxiliary Information

In an embodiment, the information present in the SAIInfoBox provides static information needed to process the sample auxiliary information. In certain cases, there may be information which is more dynamic that would change over time or information which would apply to only a group of sample auxiliary information.

In an embodiment, the dynamic information that would change over time or information which would apply to only a group of sample auxiliary information may be signaled using the sample-to-group mechanism. In an embodiment, the sample-to-group used for grouping sample auxiliary information may include a mapping from the sample-to-group to the specific sample auxiliary information either by having the same sai_ID in the SAIInfoBox or by having the same aux_info_type or by having the same aux_info_type_parameter or by having same combination of any the parameters specified before as the one used for defining the sample auxiliary information.

In an embodiment, the sample-to-group box used for grouping sample auxiliary information may have the grouping_type equal to ‘saig’ indicating that the sample-to-group box is used for grouping sample auxiliary information.

In an embodiment, any new sample-to-group box used for grouping sample auxiliary information should be derived from the sample-to-group box with grouping_type equal to ‘saig’. In an embodiment the sample-to-group box with grouping_type equal to ‘saig’ contains the sai_grouping_type parameter (indicating the grouping type used for grouping sample auxiliary information), the sai_ID (the ID of the sample auxiliary information to which the sample-to-group belongs to), the aux_info_type (the aux_info_type of the sample auxiliary information to which the sample-to-group belongs to) the aux_info_type_parameter (the aux_info_type_parameter of the sample auxiliary information to which the sample-to-group belongs to)

In an embodiment any other configuration box(es) needed to decode/process a specific sample auxiliary information may be present at the same level as the corresponding SAIBox.

In an embodiment, if a track contains multiple sample auxiliary information which needs configuration box(es) for decoding/processing the corresponding sample auxiliary information then each configuration box may be contained in a new box called SAIConfigurationBox

In an example embodiment, the syntax of SAIConfigurationBox is defined below:

```
aligned(8) class SAIConfigurationBox
  extends FullBox(‘scon’, version, flags)
{
  unsigned int(16) configuration_count;
  for (i=1; i<= configuration _count; i++) {
    ConfigurationBox configuration_information;
  }
}
```

Where the configuration count indicates the number of entries in the following array.

configuration_information contains the configuration related information needed to decode/process the sample auxiliary information this is different from the content_encoding method defined in SAIInfoEntry.

In an embodiment, when the SAIConfigurationBox is at the same level as the SAIBox and contains multiple configuration information entries then the SAIInfoBox may contain additional flag called the sai_configration_flag which when set to 1 indicates that the specific sample auxiliary information additional has a configuration information to be used for decoding/processing of the sample auxiliary information. When sai_configration_flag is set to 0, it indicates that the specific sample auxiliary information does not have any additional configuration information to be used for decoding/processing of the sample auxiliary information.

In an embodiment, when sai_configration_flag is set to 1, the SAIInfoBox may contain additional parameter called the sai_configuration_index which starts with value 1 and above and indicates the index of the configuration information within the SAIConfigurationBox, where the first configuration information within the SAIConfigurationBox has index 1.

In an alternate embodiment configuration information for a specific sample auxiliary information may be present within the SAIInfoBox.

In another alternate embodiment, the configuration information for a specific sample auxiliary information may be present in the SAIDescriptionBox specified above.

### Track SampleEntry Comprising ConfigurationBox's for Single Layer, and Track Comprising Sample Auxiliary Information Boxes for Other Layers

It is assumed herein that there exists a multilayer bitstream with two or more layers. Wherein the bitstream contains access units for example NAL units with nuh_layer_id=0 and at least one additional layer with NAL units having nuh_layer_id!=0. The multilayer bitstream is encapsulated into track of a file format, for example, ISOBMFF. For example, consider a LCEVC bitstream with the base layer coded with AVC codec. The LCEVC enhancement layer bitstream is stored as sample auxiliary information.

The sample entry of the track comprises 4cc for single layer bitstream, however, the sample entry comprises ConfigurationBox of the single layer. For example consider a AVC track with avc1 sample entry.

In an example embodiment, the SAIDescriptionBox within the SAIBox contains ConfigurationBox for the additional layers of a multilayer bitstream. For example SAIDescriptionBox contains ConfigurationBox for LCEVC enhancement layer bitstream

In an embodiment, the single layer bitstream is stored within the samples of a single layer Sample entry track and other additional layers of a multi-layer bitstream is stored within the sample auxiliary information. The information needed to process the additional layers within the sample auxiliary information is contained in the SAIInfoBox.

In an embodiment, the aux_info_type or the aux_info_type_parameter within the SAIInfoBox carries the value of the samplentry to which the additional layers belong to. For example the sample entry of the LCEVC enhancement layer bitstream

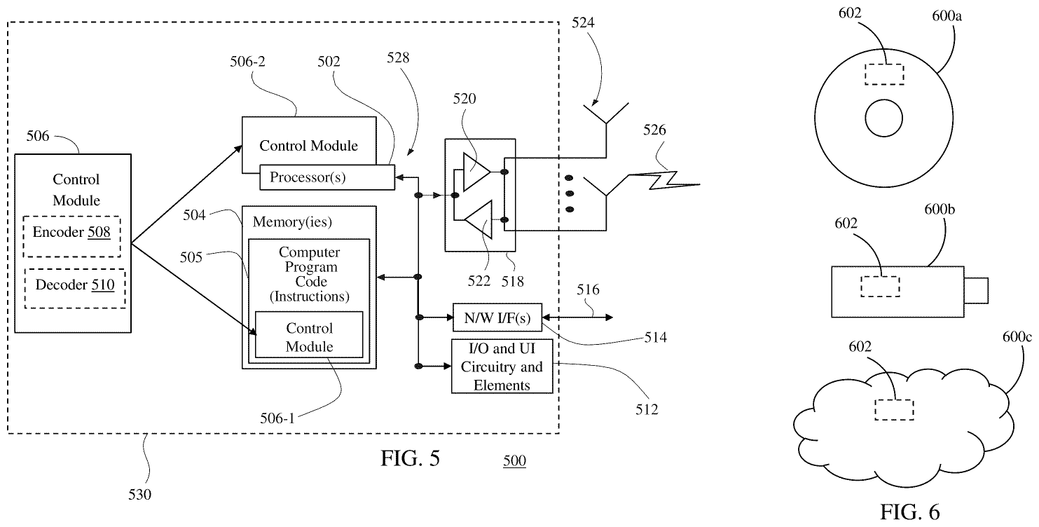

FIG. 5 is an example apparatus 500, which may be implemented in hardware, configured to implement the examples described herein. The apparatus 500 comprises at least one processor 502 (e.g., an FPGA and/or CPU), at least one memory 504 including computer program code 505, the computer program code 505 having instructions to carry out the methods described herein, wherein the at least one memory 504 and the computer program code 505 are configured to, with the at least one processor 502, cause the apparatus 500 to implement circuitry, a process, component, module, or function (implemented with control module 506) to implement the examples described herein, including generic sample auxiliary information signaling. Optionally included encoder 508 of the control module 506 implements encoding based on the examples described herein, and optionally included decoder 510 implements decoding based on the examples described herein. The at least one memory 504 may be a non-transitory memory, a transitory memory, a volatile memory (e.g., RAM), or a non-volatile memory (e.g., ROM).

The apparatus 500 includes a display and/or I/O interface 512, which includes user interface (UI) circuitry and elements, that may be used to display features or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 500 includes one or more communication e.g., network (N/W) interfaces (I/F(s)) 514. The communication I/F(s) 514 may be wired and/or wireless and communicate over the Internet/other network(s) via any communication technique including via one or more links 516. The communication I/F(s) 514 may comprise one or more transmitters or one or more receivers.

The transceiver 518 comprises one or more transmitters 520 and one or more receivers 522. The transceiver 518 and/or communication I/F(s) 514 may comprise standard well-known components such as an amplifier, filter, frequency-converter, (de) modulator, and encoder/decoder circuitries and one or more antennas, such as antennas 524 used for communication over wireless link 526.

The control module 506 of the apparatus 500 comprises one of or both parts 506-1 and/or 506-2, which may be implemented in a number of ways. The control module 506 may be implemented in hardware as control module 506-1, such as being implemented as part of the at least one processor 502. The control module 506-1 may be implemented also as an integrated circuit or through other hardware such as a programmable gate array. In another example, the control module 506 may be implemented as control module 506-2, which is implemented as computer program code (having corresponding instructions) 505 and is executed by the at least one processor 502. For instance, the at least one memory 504 store instructions that, when executed by the at least one processor 502, cause the apparatus 500 to perform one or more of the operations as described herein. Furthermore, the at least one processor 502, the at least one memory 504, and example algorithms (e.g., as flowcharts and/or signaling diagrams), encoded as instructions, programs, or code, are means for causing performance of the operations described herein.

The apparatus 500 to implement the functionality of control module 506 may correspond to any of the apparatuses depicted herein. Alternatively, apparatus 500 and its elements may not correspond to any of the other apparatuses depicted herein, as apparatus 500 may be part of a self-organizing/optimizing network (SON) node or other node, such as a node in a cloud.

The apparatus 500 may also be distributed throughout the network including within and between apparatus 500 and any network element (such as a base station and/or terminal device and/or user equipment).

Interface 528 enables data communication and signaling between the various items of apparatus 500, as shown in FIG. 5. For example, the interface 528 may be one or more buses such as address, data, or control buses, and may include any interconnection mechanism, such as a series of lines on a motherboard or integrated circuit, fiber optics or other optical communication equipment, and the like. Computer program code (e.g., instructions) 505, including control module 506 may comprise object-oriented software configured to pass data or messages between objects within computer program code 505. The apparatus 500 need not comprise each of the features mentioned, or may comprise other features as well. The various components of apparatus 500 may at least partially reside in a housing 530, or a subset of the various components of apparatus 500 may at least partially be located in different housings, which different housings may include housing 530.

FIG. 6 shows a schematic representation of non-volatile memory media 600a (e.g., computer/compact disc (CD) or digital versatile disc (DVD)) and 600b (e.g., universal serial bus (USB) memory stick) and 600c (e.g., cloud storage for downloading instructions and/or parameters 602 or receiving emailed instructions and/or parameters 602) storing instructions and/or parameters 602 which when executed by a processor allows the processor to perform one or more of the operations of the methods described herein. Instructions and/or parameters 602 may represent or correspond to a non-transitory computer readable medium.

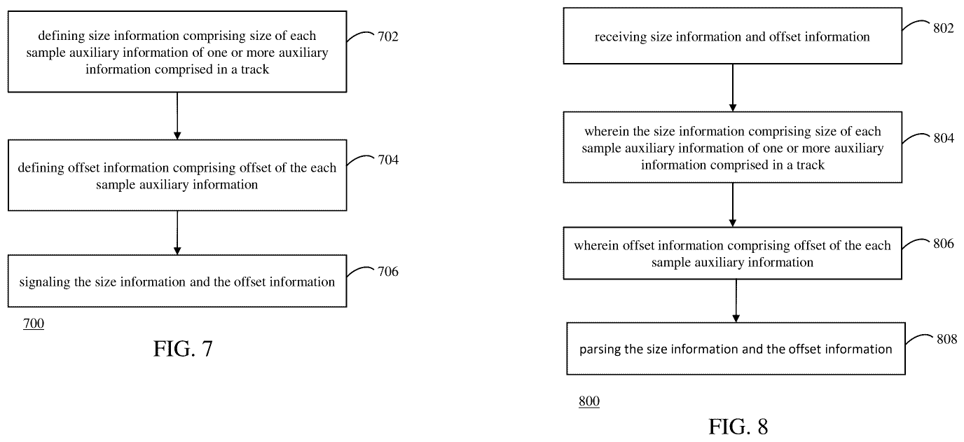

FIG. 7 is an example method 700 performed with an encoder, based on the embodiments described herein. At 702, the method 700 includes defining size information comprising size of each sample auxiliary information of one or more sample auxiliary information comprised in a track. At 704, the method 700 includes defining offset information comprising offset of the each sample auxiliary information. At 706, the method 700 includes signaling the size information and the offset information.

In an embodiment, the method 700 may further include defining a new information box comprising information to process the one or more sample auxiliary information.

In an embodiment, when the track comprises the one or more sample auxiliary information, the method 700 may further include: defining presence of the one or more sample auxiliary information by using the new information box.

The method 700 may be performed with an encoding apparatus, such as the apparatus 100, 500, apparatuses depicted in FIG. 3 and FIG. 4, for example, the transmitting apparatus 406 with the encoder 402, or the apparatus 400 with the encoder 402.

FIG. 8 is an example method 800 performed with a decoder, based on the example embodiments described herein. At 802, the method 800 includes receiving size information and offset information. At 804, the method 800 includes, wherein the size information comprises size of each sample auxiliary information of one or more sample auxiliary information comprised in a track. At 806, the method 800 includes, wherein offset information comprises offset of the each sample auxiliary information; and parsing the size information and the offset information.

The method 800 may be performed with a decoding apparatus, such as the apparatus 100, 500, apparatuses depicted in FIG. 3 and FIG. 4, for example, the receiving apparatus 410 with the decoder 412, or the apparatus 400 with the decoder 412.

As described above, FIGS. 7 and 8 include flowcharts of an apparatus (e.g., 100, 400, 500, or any other apparatuses described herein), method, and computer program product according to certain example embodiments. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory (e.g., 112 or 504) of an apparatus employing an embodiment of the present invention and executed by processing circuitry (e.g., 110 or 502) of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

A computer program product is therefore defined in those instances in which the computer program instructions, such as computer-readable program code portions, are stored by at least one non-transitory computer-readable storage medium with the computer program instructions, such as the computer-readable program code portions, being configured, upon execution, to perform the functions described above, such as in conjunction with the flowchart(s) of FIGS. 7 and 8. In other embodiments, the computer program instructions, such as the computer-readable program code portions, need not be stored or otherwise embodied by a non-transitory computer-readable storage medium, but may, instead, be embodied by a transitory medium with the computer program instructions, such as the computer-readable program code portions, still being configured, upon execution, to perform the functions described above.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, may be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Some embodiments have been described in relation to one or more neural networks performing visual temporal extrapolation. It is to be understood that embodiments can be realized with any generative modelling neural networks.

In the above, some example embodiments have been described with the help of syntax of the bitstream. It needs to be understood, however, that the corresponding structure and/or computer program may reside at the encoder for generating the bitstream and/or at the decoder for decoding the bitstream.

In the above, where example embodiments have been described with reference to an encoder, it needs to be understood that the resulting bitstream and the decoder have corresponding elements in them. Likewise, where example embodiments have been described with reference to a decoder, it needs to be understood that the encoder has structure and/or computer program for generating the bitstream to be decoded by the decoder.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Accordingly, the description is intended to embrace all such alternatives, modifications and variances which fall within the scope of the appended claims. Although specific terms are employed herein, they are used in a generic and descriptive sense only and not for purposes of limitation.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

References to a ‘computer’, ‘processor’, etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, and the like.

As used herein, the term ‘circuitry’ may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even when the software or firmware is not physically present. This description of ‘circuitry’ applies to uses of this term in this application. As a further example, as used herein, the term ‘circuitry’ would also cover an implementation of merely a processor (or multiple processors) or a portion of a processor and its (or their) accompanying software and/or firmware. The term ‘circuitry’ would also cover, for example and when applicable to the particular element, a baseband integrated circuit or applications processor integrated circuit for a mobile phone or a similar integrated circuit in a server, a cellular network device, or another network device.

Circuitry or Circuit: As used in this application, the term ‘circuitry’ or ‘circuit’ may refer to one or more or all of the following:
(a) hardware-only circuit implementations (such as implementations in only analog and/or digital circuitry); and
(b) combinations of hardware circuits and software, such as (as applicable):
   (i) a combination of analog and/or digital hardware circuit(s) with software/firmware; and
   (ii) any portions of hardware processor(s) with software (including digital signal processor(s)), software, and memory(ies) that work together to cause an apparatus, such as a mobile phone or server, to perform various functions); and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example, and when applicable to the particular claim element, a baseband integrated circuit or processor integrated circuit for a mobile device or a similar integrated circuit in server, a cellular network device, or other computing or network device.

What is claimed is:

1. An apparatus comprising:
at least one processor; and
at least one memory storing instructions that, when executed by the at least one processor, cause the apparatus at least to perform:
defining size information comprising size of each sample auxiliary information of one or more sample auxiliary information comprised in a track;
defining offset information comprising offset of the each sample auxiliary information;
defining a new information box comprising information needed to process the one or more sample auxiliary information; and
signaling the size information, the offset information, and the new information box.

2. The apparatus of claim 1, wherein when the track comprises the one or more sample auxiliary information, the apparatus is further caused to perform: defining presence of the one or more sample auxiliary information by using the new information box.

3. The apparatus of claim 1, wherein the new information box comprises a sample auxiliary information info box.

4. The apparatus of claim 1, wherein the new information box is comprised in: a sample entry of the track, a sample table box, or in a track fragment box.

5. The apparatus claim 1 wherein, the apparatus is further caused to perform: defining an entry count for providing a count of a number of entries of the one or more sample auxiliary information in a following array.

6. The apparatus of claim 5, wherein the apparatus is further caused to perform: defining an array for indicating an entry for the sample auxiliary information.

7. The apparatus of claim 1, wherein the sample auxiliary information is protected using an encryption scheme and/or wherein the sample auxiliary information is encoded with a content encoding method, wherein the content encoding method changes format of the sample auxiliary information data.

8. The apparatus of claim 7, wherein when both content encoding and protection are indicated for the sample auxiliary information, a reader needs to un-protect the sample auxiliary information data, before the sample auxiliary information content encoding is decoded.

9. The apparatus of claim 1, wherein the new information box comprises an array of entries, and wherein each entry comprises boxes comprising the information needed to process the sample auxiliary information.

10. The apparatus of claim 1, wherein the apparatus is further caused to perform: defining a protection box for providing an array of sample auxiliary information protection information for use by a corresponding sample auxiliary information in the new information box.

11. A method comprising:
defining size information comprising size of each sample auxiliary information of one or more sample auxiliary information comprised in a track;
defining offset information comprising offset of the each sample auxiliary information;
defining a new information box comprising information to process the one or more sample auxiliary information; and
signaling the size information, the offset information, and the new information box.

12. The method of claim 11, wherein when the track comprises the one or more sample auxiliary information, the apparatus is further caused to perform: defining presence of the one or more sample auxiliary information by using the new information box.

13. The method of claim 11, wherein the new information box comprises a sample auxiliary information info box.

14. The method of claim 11, wherein the new information box is comprised in: a sample entry of the track, a sample table box, or in a track fragment box.

15. The method claim 11 wherein, the apparatus is further caused to perform: defining an entry count for providing a count of a number of entries of the one or more sample auxiliary information in a following array.

16. The method of claim 15, wherein the apparatus is further caused to perform: defining an array for indicating an entry for the sample auxiliary information.

17. The method of claim 11, wherein the sample auxiliary information is protected using an encryption scheme and/or wherein the sample auxiliary information is encoded with a content encoding method, wherein the content encoding method changes format of the sample auxiliary information data.

18. The method of claim 17, wherein when both content encoding and protection are indicated for the sample auxiliary information, a reader needs to un-protect the sample auxiliary information data, before the sample auxiliary information content encoding is decoded.

19. The method of claim 11, wherein the new information box comprises an array of entries, and wherein each entry comprises boxes comprising the information needed to process the sample auxiliary information.

20. An apparatus comprising:
at least one processor; and
at least one memory storing instructions that, when executed by the at least one processor, cause the apparatus at least to perform:
receiving size information, offset information, and a new information box, wherein the size information comprises size of each sample auxiliary information of one or more sample auxiliary information comprised in a track, and wherein the offset information comprises offset of the each sample auxiliary information, and wherein the new information box comprises information to process the one or more sample auxiliary information; and
parsing the size information, the offset information, and the new information box.
